(19) United States
(12) Patent Application Publication
(10) Pub. No.: US 2017/0111300 A1
(43) Pub. Date: Apr. 20, 2017

(54) SELECTIVELY BLOCKING RESPONSES FROM MEMBERS IN A CONVERSATION THREAD

(71) Applicant: International Business Machines Corporation, Armonk, NY (US)

(72) Inventors: Snehal S. Devasthali, Pune (IN); Bhavana R. Gaikwad, Pune (IN); Girish Padmanabhan, Pune (IN); Prasad P. Purandare, Dhankawdi (IN)

(21) Appl. No.: 14/883,953

(22) Filed: Oct. 15, 2015

(51) Int. Cl. H04L 12/58

(52) U.S. Cl. CPC H04L 51/12; H04L 51/16

(57) ABSTRACT

An approach for selectively blocking responses from members in a conversation thread, such as an email message or an instant messaging session. A first member in a conversation thread receives notification that one or more other members are reading the thread or typing responses and the first member can selectively block the one or more other members from posting responses until the first member has posted a response or until the first member manually unblocks the one or more other members. A member that has been blocked in the conversation thread can send a request to whoever blocked them to be allowed to post a response in the thread.

### BACKGROUND

The present invention relates generally to the field of conversation threads and more particularly to selectively blocking responses from members in a conversation thread.

A conversation thread, in general, is a digitally transcribed conversation often involving two or more members and can occur in messaging programs such as electronic mail (email) or instant messaging (IM). Typically, any of the members in the thread can send a message or a response to all or some of the other members at any time. However, there are situations where it may be desirable to selectively block some of the members from posting a message in the thread, even if it is in response to an original message. This can be done for a number of reasons, including managing the volume of incoming messages to prevent interruptions and preventing someone from posting a response that might be problematic due to a lack of up to date or better information.

### SUMMARY

According to one embodiment of the present invention, a method for blocking responses from members in a conversation thread is provided, the method comprising detecting a first one or more members taking one or more actions in a conversation thread, wherein the one or more actions are at least one of reading the conversation thread and preparing a response in the conversation thread; and blocking at least one of the first one or more members from posting one or more responses, respectively, in the conversation thread based on a user selecting an option to block. A corresponding computer program product and computer system are also disclosed herein.

### BRIEF DESCRIPTION OF THE DRAWINGS

FIG. 1A-B is a functional block diagram illustrating a distributed data processing environment and a functional block diagram illustrating components of a response blocking program, in accordance with an embodiment of the present invention;

FIG. 2 is a block diagram illustrating an interaction between members in a conversation thread, in accordance with an embodiment of the present invention;

FIG. 3A-B is an instant messaging window displaying options to block chat members from responding and an instant messaging window wherein response capabilities have been blocked, respectively, in accordance with an embodiment of the present invention;

FIG. 4A-B is an email message displaying options to block responses from recipients and an email message wherein response capabilities have been blocked, respectively, in accordance with an embodiment of the present invention; and

FIG. 5 sets forth a generalized architecture of computing platforms suitable for at least one embodiment of the present invention.

### DETAILED DESCRIPTION

Embodiments of the present invention recognize that some members participating in a conversation thread, such as, but not limited to, an electronic mail (email) message or an instant messaging (IM) conversation, would benefit from the capability to selectively block responses from other members also participating in the conversation thread in certain situations. For example, member A in a conversation thread may have more up to date information than member B regarding a query that was posed and member A can therefore, to avoid any confusion, selectively block member B from posting a response, even if member B is in the middle of typing a response, until member A has first had a chance to reply. There are many reasons why certain members in a conversation thread would need to be able to selectively block responses from some or all other members in the thread for a time and embodiments of the present invention provide the capability to do so.

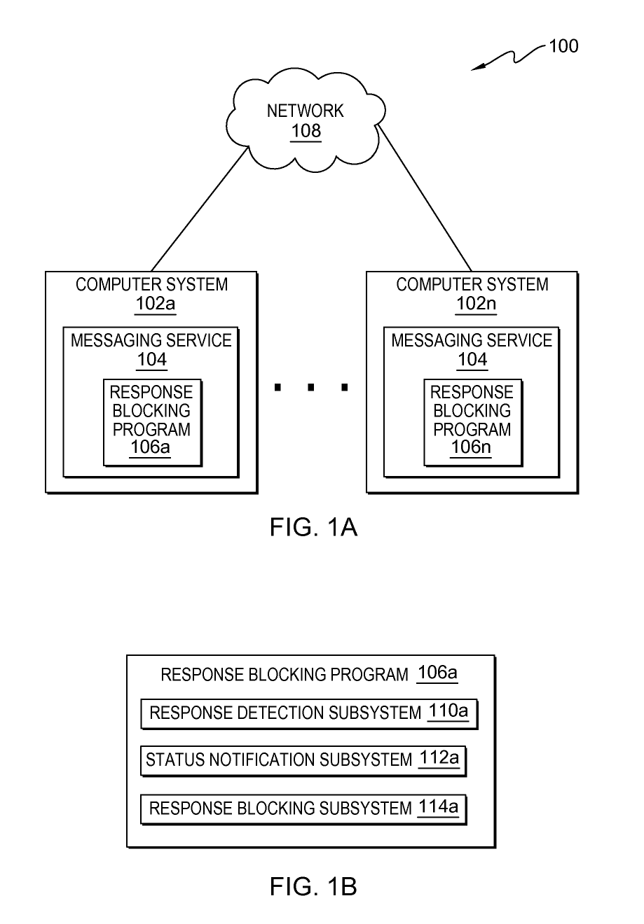

The present invention will now be described in detail with reference to the figures. FIG. 1A is a functional block diagram illustrating a distributed data processing environment 100 in accordance with one embodiment of the present invention. Distributed data processing environment 100 includes computer systems 102a-n, all interconnected over network 108. In general, computer systems 102a-n represent any plurality of computer systems.

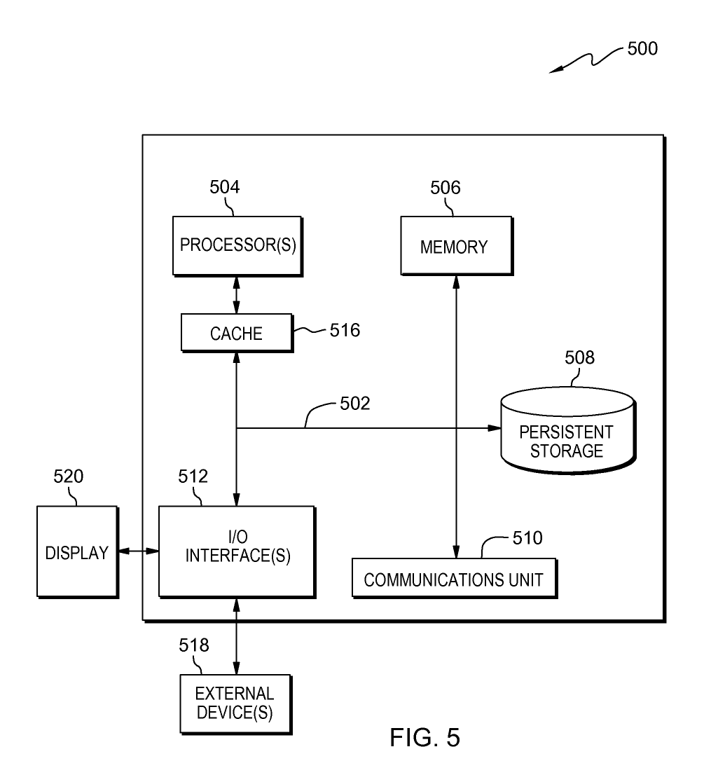

Computer systems 102a-n may be laptop computers, tablet computers, netbook computers, personal computers (PC), desktop computers, personal digital assistants (PDA), smart phones, or any programmable electronic devices capable of communicating with other computer systems 102a-n via network 110. Computer systems 102a-n have messaging service 104 installed which comprise response blocking programs 106a-n. Messaging service 104 can be any service that allows communication between one or more users, such as, but not limited to, an email service or an IM service and it should be noted that messaging service 104 can be either a stand-alone application or a program accessed on a website via a web browser. Response blocking programs 106a-n can be built into messaging service 104 but it should also be noted that in other embodiments, any of response blocking programs 106a-n can be separate applications that can be employed by messaging service 104. Computer systems 102a-n may include internal and external hardware components, as depicted and described in further detail with respect to FIG. 5.

Network 108 can be, for example, a local area network (LAN), a wide area network (WAN) such as the Internet, or a combination of the two, and can include wired, wireless, or fiber optic connections. In general, network 108 can be any combination of connections and protocols that will support communications between computer systems 102a-n.

Looking to FIG. 1B, response blocking program 106a comprises response detection subsystem 110a, status notification subsystem 112a and response blocking subsystem 114a though it should be noted that the description provided herein can be extended to any of the other response blocking programs 106b-n. Response detection subsystem 110a can detect when a member using computer system 102a in a conversation thread is typing a response intended for one or more recipients in the conversation thread and/or when the member using computer system 102a is reading the conversation thread (i.e., the conversation thread window is active and/or opened).

Status notification subsystem 112a provides one or more notifications to the member using computer system 102a for situations such as, but not limited to, one or more other members in the conversation thread are reading the thread or preparing a response, one or more members in the conversation thread have been selectively blocked from responding by another member, one or more members are requesting to be unblocked by another member and/or one or more members have been unblocked by another member. The one or more notifications can appear, for example, as status messages in the conversation thread window (which can include the names, i.e., the identity, of the one or more members) and/or as an icon appearing on or next to the name of a conversation thread member who is currently reading the thread or preparing a response in it. Further, status notification subsystem 112a can receive data from response detection subsystem 110a and response blocking subsystem 114a about actions being taken by the member using computer system 102a, which will be subsequently discussed in greater detail.

Response blocking subsystem 114a allows the member using computer system 102a in the conversation thread to selectively block one or more other members also in the thread from posting a response, or will block the member using computer system 102a if they have been blocked by any of the other members. A member can selectively block the one or more other members via one or more blocking buttons appearing in the conversation thread window which can be selected prior to or during notification that the one or more other members are reading the thread or typing responses. Individual members can be blocked one at a time or all other members in a conversation thread (besides the member doing the blocking) can be blocked at once via a “block all” button. If selectively blocked, a member may be disabled from entering text in a text field in the conversation thread window and will not be able to post a response or selectively block whoever blocked them until they are unblocked. A member can be unblocked automatically once the member who has blocked them has first posted a response to the thread, or a manual unblocking can occur if the member who has blocked them selects an “unblock” button. Further, a member who has been selectively blocked can select a “request access” button, which will send a notification requesting an override for the block to the member who has blocked them.

To illustrate how response blocking program 106a can provide this blocking and notification functionality in a conversation thread with a plurality of conversation thread members across multiple computer systems 102a-n, consider computer system 102a with response blocking program 106a (on messaging service 104) comprising response detection subsystem 110a, status notification subsystem 112a and response blocking subsystem 114a. Status notification subsystem 112a will be in communication with response detection subsystem 110a and response blocking subsystem 114a to receive data that the member using computer system 102a is taking an action (e.g., they are reading the conversation thread, preparing a response, blocking another member, etc. . . . ). This data which is received by status notification subsystem 112a can be communicated via network 108 to response blocking programs 106b-n (i.e., the other members in the conversation thread) wherein status notification subsystems 112b-n, respectively associated with response blocking programs 106b-n, will receive the data and provide the appropriate notifications about the actions currently being taken by the user of computer system 102a, or the actions being taken by another member in a similar manner. If, for example, the data received by notification subsystem 112b indicates that the member using computer system 102b is being blocked by any other member, this will be communicated to response blocking subsystem 114b which will do the blocking.

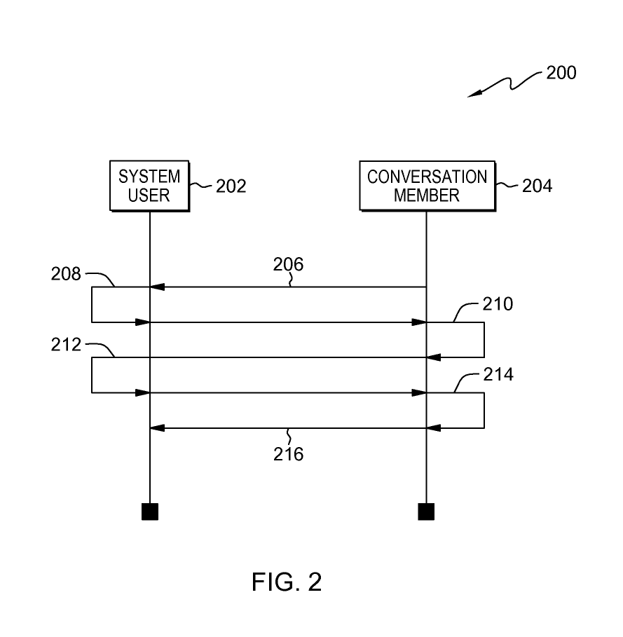

Turning to FIG. 2, a block diagram 200 illustrating an interaction between two members in a conversation thread is presented, in accordance with an embodiment of the present invention. System user 202 and conversation member 204, who can for illustrative purposes be respectively using computer system 106a and computer system 106b, are in a conversation thread with other members (not shown) and conversation member 204 begins typing a response 206, which is detected by response detection subsystem 110b and communicated to status notification subsystem 112b. System user 202 receives 208 notification via status notification subsystem 112a that conversation member 204 is typing and system user 202 selectively blocks them from posting their response using response blocking subsystem 114a. Conversation member 204 receives notification 210 from status notification subsystem 112b via a status message that they have been blocked from posting a response by system user 202 and conversation member 204 selects a request access button to request an override for the block. System user 202 receives 212 the request for a block override from conversation member 204 and chooses to remove the block and allow them to post a response. Conversation member 204 is notified 214 that they have been unblocked by system user 202 and conversation member 204 enters their response into the conversation thread, where it is received 216 by system user 202 and any other designated recipients in the conversation thread.

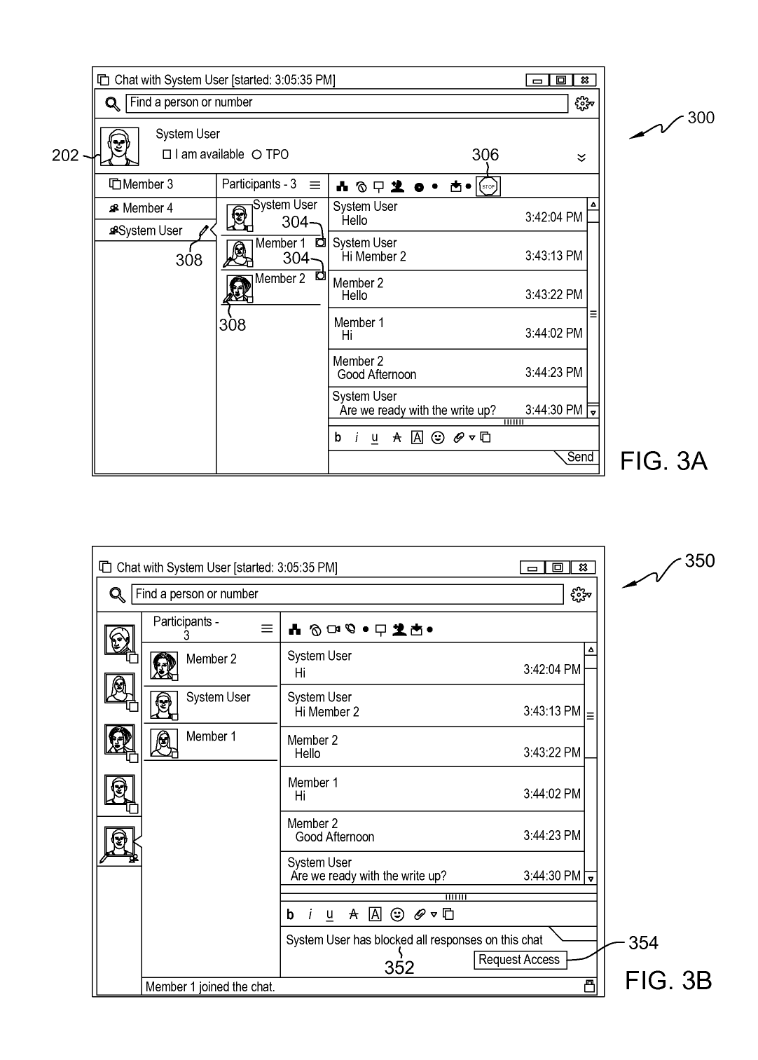

FIG. 3A is an IM window 300 showing a conversation between members in a thread, in accordance with an embodiment of the present invention. System user 202 is presented with block member buttons 304 that will disable the ability for individual members in the conversation thread to post a response and a block all button 306 that will prevent all members (with the exception of system user 202 himself) from posting a response. System user 202 will have one or more notifications 308 when other members are typing responses in the thread and system user 202 has the option to block the other members from responding either actively, i.e., while the other members are typing a response, or preemptively, i.e., before the other members start typing. If a block member button 304 or the block all button 306 is selected, system user 202 can be presented with another button (not shown) allowing them to manually unblock whichever members they have selectively blocked from posting a response.

FIG. 3B is an IM window 350 showing a conversation wherein system user 202 has blocked all responses from being posted, in accordance with an embodiment of the present invention. Status message 352 is notifying a conversation member that all responses in the thread by any member other than system user 202 have been blocked. The blocked conversation member is presented, however, with a request access button 354 which will send a notification to system user 202, when selected, that the blocked member requests an override for the block so that they can be allowed to post a response. If system user 202 approves the block override, the formerly blocked conversation member can be notified that they have been unblocked in the thread and resume normal chat functionality. It should be noted that if a conversation member has been selectively blocked, their text field can be disabled so that the blocked member cannot further edit or enter text until unblocked.

It should be noted that a user can preconfigure the settings related to the blocking and unblocking functionality of embodiments of the present invention in a user interface (UI) module. For example, system user 202 can choose to have everyone they have selectively blocked be automatically unblocked once system user 202 has posted their response in the conversation thread, or after a certain predetermined period of time. Alternatively, system user 202 can choose to disable any automatic unblocking functionality as previously discussed and require that an unblocking of any members occurs only when system user 202 manually unblocks them. Further, the settings can be preconfigured to establish a hierarchy of conversation member seniority (which can be agreed upon based on a predetermined criteria) wherein certain members in a conversation thread have privileges that the other members do not have. These privileges can include, but are not limited to, the exclusive capability to selectively block other members, an immunity to being blocked by any other member, an automatic block override granted upon request and the ability to unblock any other member that is blocked. It should be further noted that there can be levels of seniority among the members having these privileges.

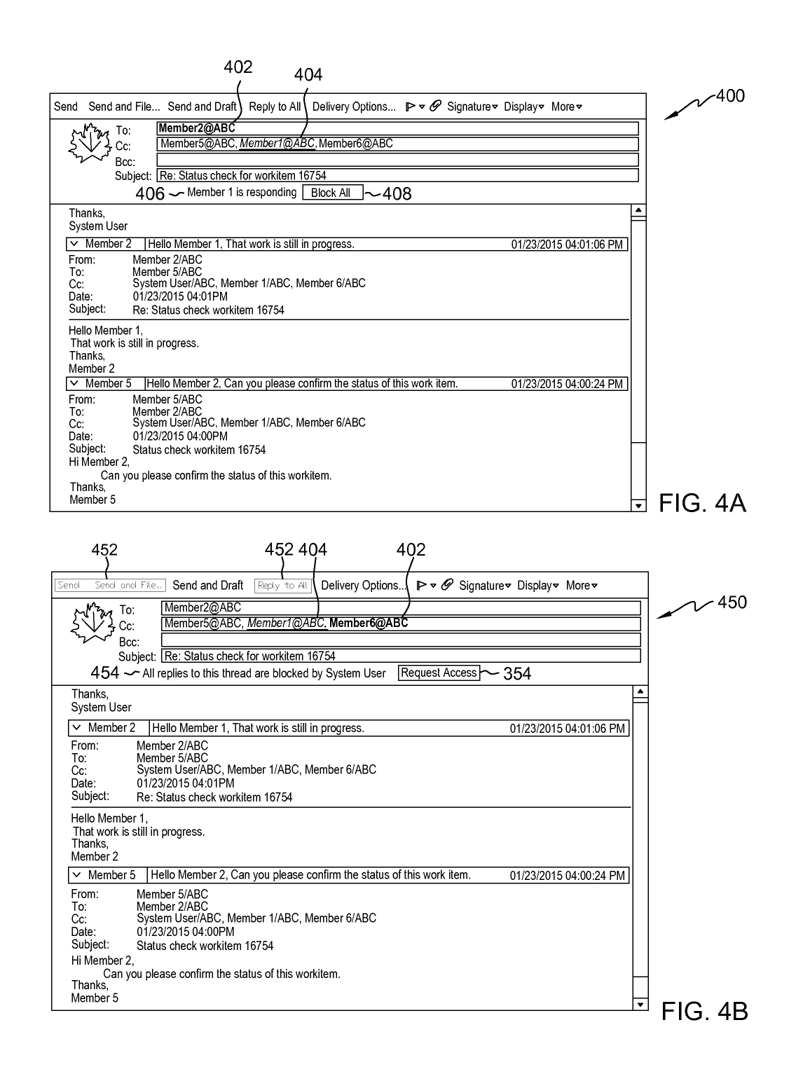

Turning to FIG. 4A, an email message 400 with members in a conversation thread is displayed, in accordance with an embodiment of the present invention. System user 202, who is preparing the email, is presented with notifications on the names of the thread members that show who are currently reading the email thread and who are currently posting responses to it. In the To: line of email message 400, notification 402 indicates a thread member who is currently reading the email thread and in the Cc: line, notification 404 indicates a thread member who is currently typing a response to be posted in the thread. It is noteworthy that notifications 402, 404 can also appear in the Bcc: line of email message 400 or anywhere within the thread that the other member's names appear. Further, some examples of notifications 402, 404 can be, but are not limited to, highlighting in a certain color and/or font alterations (such as bolding, italicization, underlining, etc. . . . ). Status message 406 is displayed below the subject line which is notifying system user 202 that a member in the email thread is preparing a response. It should be noted that status message 406 can include the names of multiple members that may be simultaneously preparing a response in the email thread or reading the thread. Next to status message 406 is a block all button 408 which will disable all members in the email thread from posting a response. Optionally, system user 202 can be presented with other buttons (not shown) that allow them to selectively block individual members, regardless of whether or not they are currently preparing a response to the email thread.

FIG. 4B is an email message 450 for a conversation thread member who has been blocked by system user 202. Status message 454 indicates that all members in the thread (with the exception of system user 202) are currently blocked from posting a response in the thread and actions 452 are currently disabled and can be displayed in faded text when disabled. Actions 452 which may be disabled as a result of selective blocking can include, but are not limited to, send, send and file, reply and/or reply to all and it should be noted that these disabled actions 452 can be based on the messaging service 104 being used. It should also be noted that status message 454 can also indicate that an individual member or a subset of members in the conversation thread have been blocked by another member. Request access button 354 can be selected by a blocked member to request an override from whoever blocked them, allowing the formerly blocked member to enter a response in the conversation thread.

It should be noted that if an email message currently has any selective blocking on it, this can be indicated to a member when viewing the email in their inbox, regardless of which members the block applies to. For example, in a list of emails in their inbox, an email thread member can have a notification such as, but not limited to, the email being highlighted in a certain color in the list, indicating that there is some blocking on that thread and the email can also have an associated status message indicating who has been selectively blocked in it and by whom they have been blocked. Further, certain actions 452, such as those previously discussed and others, can also be disabled from the inbox if a blocked email message is selected.

FIG. 5 depicts a block diagram 500 of components of computer systems 102a-n in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer systems 102a-n include communications fabric 502, which provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Messaging service 104 and/or response blocking programs 106a-n may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Messaging service 104 and/or response blocking programs 106a-n may be downloaded to persistent storage 508 through communications unit 510.

I/O interface(s) 512 allows for input and output of data with other devices that may be connected to computer systems 102a-n. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., messaging service 104 and response blocking programs 106a-n, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for blocking responses from members in a conversation thread, the method comprising:
detecting a first one or more members taking one or more actions in a conversation thread, wherein the one or more actions are at least one of reading the conversation thread and preparing a response in the conversation thread; and
blocking at least one of the first one or more members from posting one or more responses, respectively, in the conversation thread based on a user selecting an option to block.

2. The method of claim 1, wherein the at least one of the first one or more members are unblocked based on the user selecting an option to unblock or an automatic unblocking when the user enters a response in the conversation thread.

3. The method of claim 1, wherein the at least one of the first one or more members can request to be unblocked.

4. The method of claim 1, wherein one or more notifications are provided, wherein the one or more notifications are associated with an identity of the first one or more members and the one or more actions.

5. The method of claim 4, wherein the one or more notifications comprise at least one of an icon, a status message, text highlighting and font alterations.

6. The method of claim 1, wherein a second one or more members in the conversation thread have one or more privileges associated with seniority based on a predetermined criteria.

7. The method of claim 6, wherein the one or more privileges comprise at least one of an exclusive ability to block other members, an immunity from being blocked by other members, an automatic block override responsive to a selection of an option to request access if blocked and an ability to unblock any member that is blocked.

8. A computer program product for blocking responses from members in a conversation thread, the computer program product comprising:
one or more computer readable storage media and program instructions stored on the one or more computer readable storage media, the program instructions comprising:
program instructions to detect a first one or more members taking one or more actions in a conversation thread, wherein the one or more actions are at least one of reading the conversation thread and preparing a response in the conversation thread; and
program instructions to block at least one of the first one or more members from posting one or more responses, respectively, in the conversation thread based on a user selecting an option to block.

9. The computer program product of claim 8, wherein the at least one of the first one or more members are unblocked based on the user selecting an option to unblock or an automatic unblocking when the user enters a response in the conversation thread.

10. The computer program product of claim 8, wherein the at least one of the first one or more members can request to be unblocked.

11. The computer program product of claim 8, wherein one or more notifications are provided, wherein the one or more notifications are associated with an identity of the first one or more members and the one or more actions.

12. The computer program product of claim 11, wherein the one or more notifications comprise at least one of an icon, a status message, text highlighting and font alterations.

13. The computer program product of claim 8, wherein a second one or more members in the conversation thread have one or more privileges associated with seniority based on a predetermined criteria.

14. The computer program product of claim 13, wherein the one or more privileges comprise at least one of an exclusive ability to block other members, an immunity from being blocked by other members, an automatic block override responsive to a selection of an option to request access if blocked and an ability to unblock any member that is blocked.

15. A computer system for blocking responses from members in a conversation thread, the computer system comprising:
one or more computer processors;
one or more computer readable storage media;
program instructions stored on the one or more computer readable storage media for execution by at least one of the one or more processors, the program instructions comprising:
program instructions to detect a first one or more members taking one or more actions in a conversation thread, wherein the one or more actions are at least one of reading the conversation thread and preparing a response in the conversation thread; and
program instructions to block at least one of the first one or more members from posting one or more responses, respectively, in the conversation thread based on a user selecting an option to block.

16. The computer system of claim 15, wherein the at least one of the first one or more members are unblocked based on the user selecting an option to unblock or an automatic unblocking when the user enters a response in the conversation thread.

17. The computer system of claim 15, wherein the at least one of the first one or more members can request to be unblocked.

18. The computer system of claim 15, wherein one or more notifications are provided, wherein the one or more notifications are associated with an identity of the first one or more members and the one or more actions.

19. The computer system of claim 15, wherein a second one or more members in the conversation thread have one or more privileges associated with seniority based on a predetermined criteria.

20. The computer system of claim 19, wherein the one or more privileges comprise at least one of an exclusive ability to block other members, an immunity from being blocked by other members, an automatic block override responsive to a selection of an option to request access if blocked and an ability to unblock any member that is blocked.
